(19) United States
(12) Patent Application Publication
(10) Pub. No.: US 2009/0172112 A1
(43) Pub. Date: Jul. 2, 2009

(54) INSTANT MESSAGING BASED SOCIAL INTRODUCTIONS

(75) Inventors: Gary Denner, County Kildare (IE); Ruthie D. Lyle, Durham, NC (US); Patrick J. O'Sullivan, Dublin (IE); Carol S. Zimmet, Boxborough, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/967,750

(22) Filed: Dec. 31, 2007

(51) Int. Cl. G06F 15/82; G06F 3/048

(52) U.S. Cl. 709/206; 715/810

(57) ABSTRACT

Embodiments of the present invention address deficiencies of the art in respect to instant messaging and provide a method, system and computer program product for instant messenger based social introductions. In an embodiment of the invention, a method for instant messaging based social introductions can be provided. The method can include selecting contacts from a buddy list of an instant messenger, retrieving attributes for each of the selected contacts, and generating introduction text for each of the selected contacts. Specifically, the introduction text can introduce a particular one of the selected contacts and can incorporate attributes for the particular one of the contacts. Finally, the method can include instant messaging the introduction text for each of the selected contacts to another of the selected contacts.

### BACKGROUND OF THE INVENTION

1. Field of the Invention

The present invention relates to the field of instant messaging and more particularly to referring new relationships through instant messaging.

2. Description of the Related Art

The rapid development of the Internet has led to advanced modes of communication and collaboration. Using the Internet as a backbone, individuals worldwide can converge in cyberspace to share ideas, documents and images in a manner not previously possible through conventional telephony and video conferencing. To facilitate collaboration over the Internet, a substantial collection of technologies and protocols have been assembled to effectively deliver audio, video and data over the single data communications medium of the Internet. These technologies include document libraries, instant messaging, chat rooms, and application sharing.

Conventional collaborative computing includes combinations of collaborative technologies in order to provide a means for members of a collaborative community to pool their strengths and experiences to achieve a common goal. A collaborative computing community generally can be defined by (1) a particular context, i.e. the objective of the environment, (2) membership, i.e., the participants in the environment, (3) a set of roles for the members, and (4) resources and tools which can be accessed by the membership in furtherance of the objective of the environment. Roles are names given to the people in the environment which dictate access to the resources and tools within the environment as well as define the behavior of the community members.

Amongst often used collaborative components in a collaborative environment, instant messaging remains of paramount importance. In an instant messaging environment, one or more collaborators can exchange messages shown to be arranged in a single space visible by all. Thus, the instant messaging component aims to mimic a human-to-human conversation in which the real-time nature of the exchange of written conversation between participants can be limited only by the speed in which participants can read, digest and reply to the contributions of other contributors who are party to the instant messaging session.

Oftentimes in human-to-human conversation, reference to a non-participating party can become relevant in the context of the conversation. In fact, in many cases, one may recognize the relevance of introducing different common contacts. Referred to as “networking” it is the bedrock activity of commercial interactions. Imitating networking in the virtual world of the computer network, however, has been slow to develop until recently with the advent of social networking systems. Social networking systems generally refer to computing portals in which members can be matched to other members through common interests such as common schooling, location, and even common friends. The latter element acts to infer relationships that otherwise are explicitly identified in the real, non-computing world.

Social networking systems have proven adept at inferring social introductions, and adequate in explicitly providing social introductions. In this regard, most social networking systems provide a mechanism for one member of the social networking system to request an introduction to another member. Likewise, most social networking systems provide a mechanism for one member to explicitly suggest an introduction amongst common contacts of the member. To capitalize on such an explicit introduction, however, requires members to engage directly in a social networking system. The social networking system, unlike the instant messenger, however, has not proven to be a staple application in the corporate environment where social introductions are important.

### BRIEF SUMMARY OF THE INVENTION

Embodiments of the present invention address deficiencies of the art in respect to instant messaging and provide a novel and non-obvious method, system and computer program product for instant messenger based social introductions. In an embodiment of the invention, a method for instant messaging based social introductions can be provided. The method can include selecting contacts from a buddy list of an instant messenger, retrieving attributes for each of the selected contacts, and generating introduction text for each of the selected contacts. Specifically, the introduction text can introduce a particular one of the selected contacts and can incorporate attributes for the particular one of the contacts. Finally, the method can include instant messaging the introduction text for each of the selected contacts to another of the selected contacts.

In one aspect of the embodiment, retrieving attributes for each of the selected contacts further can include filtering the attributes for each of the selected contacts according to pre-stored introduction settings. In another aspect of the embodiment, generating introduction text for each of the selected contacts further can include modifying the introduction text to account for cultural nuances associated with a culture of a selected one of the contacts. In yet another aspect of the embodiment, the method further can include tracking whether or not the selected contacts contact each other through the instant messenger. Finally, in even yet another aspect of the embodiment, the method also can include persisting the instant messaged introduction text for a selected one of the contacts receiving the instant messaged introduction text, and re-using the persisted instant messaged introduction text in providing a different introduction to a different contact in a buddy list of the selected one of the contacts.

In another embodiment of the invention, an instant messaging data processing system can be provided. The instant messaging data processing system can include an instant messaging server configured for communicative coupling to multiple different instant messaging clients over a computer communications network. Each of the instant messaging clients can provide a buddy list of contacts. The system also can include social introduction logic communicatively coupled to the instant messaging clients and the instant messaging server. The logic can include program code enabled to select contacts from a buddy list of a corresponding one of the instant messaging clients, to retrieve attributes for each of the selected contacts, to generate introduction text for each of the selected contacts, the introduction text introducing a particular one of the selected contacts and incorporating attributes for the particular one of the contacts, and to direct an instant messaging of the introduction text for each of the selected contacts to another of the selected contacts.

Optionally, the program code of the social introduction logic can be part of the instant messaging server. Alternatively, the program code of the social introduction logic can be part of each of the instant messaging clients.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for instant messenger based social introductions;

FIG. 2 is a schematic illustration of an instant messaging data processing system configured for instant messenger based social introductions; and,

FIG. 3 is a flow chart illustrating a process for instant messenger based social introductions.

### DETAILED DESCRIPTION OF THE INVENTION

Embodiments of the present invention provide a method, system and computer program product for instant messenger based social introductions. In accordance with an embodiment of the present invention, two or more different contacts in an instant messaging buddy list can be selected for introduction. Thereafter, descriptive data for the contacts can be retrieved and filtered according to established privacy rules. An introductory instant message can be generated for each of the contacts incorporating the descriptive data. Finally, each introductory message can be instant messaged to the different respective selected contacts. In this way, the ubiquity of the instant messenger can be employed to emulate express social networking.

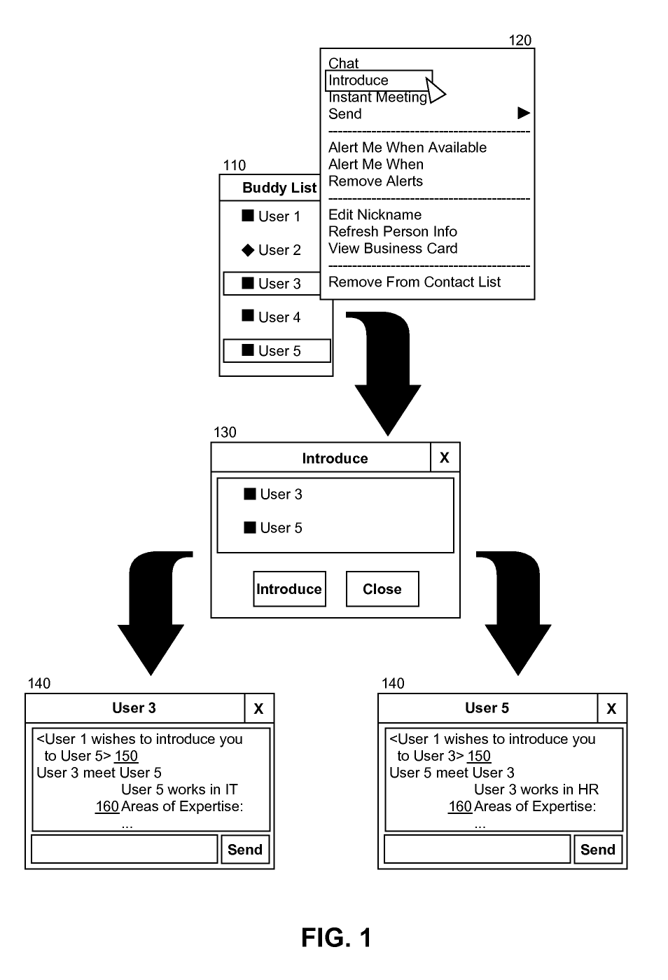

In illustration, FIG. 1 pictorially depicts a process for instant messenger based social introductions. As shown in FIG. 1, a buddy list 110 for an instant messenger can include a listing of contacts for a particular user of an instant messaging system. Each contact in the buddy list optionally can provide presence awareness showing whether or not each contact in the buddy list is available for engaging in an instant messaging session. A context menu 120 can be provided for the buddy list 120 and can include a number of invokable actions to be performed upon one or more selected contacts in the buddy list 110. Those actions include without limitation, the launching of an instant messaging session amongst selected ones of the contacts, and the creation of an instant meeting with selected ones of the contacts.

Notably, one action included in the context menu 120 can include the introduction of selected ones of the contacts in the buddy list 110. In response to the selection of the introduce entry in the context menu 120, an introduction dialog 130 can be provided. The introduction dialog 130 can include a listing of all selected contacts in the buddy list 110. Upon activation of the introduce control in the introduction dialog 130, descriptive information pertaining to each of the selected contacts can be retrieved and filtered according to established privacy rules for incorporating descriptive information in a description of each selected contact. Thereafter, an introduction message 150 can be formulated along with the filtered descriptive information 160 for each selected contact and the introduction message 150 can be transmitted to each other selected contact. Consequently, within respective instant messaging clients 140, the introduction message 150 with filtered descriptive information 160 can be viewed.

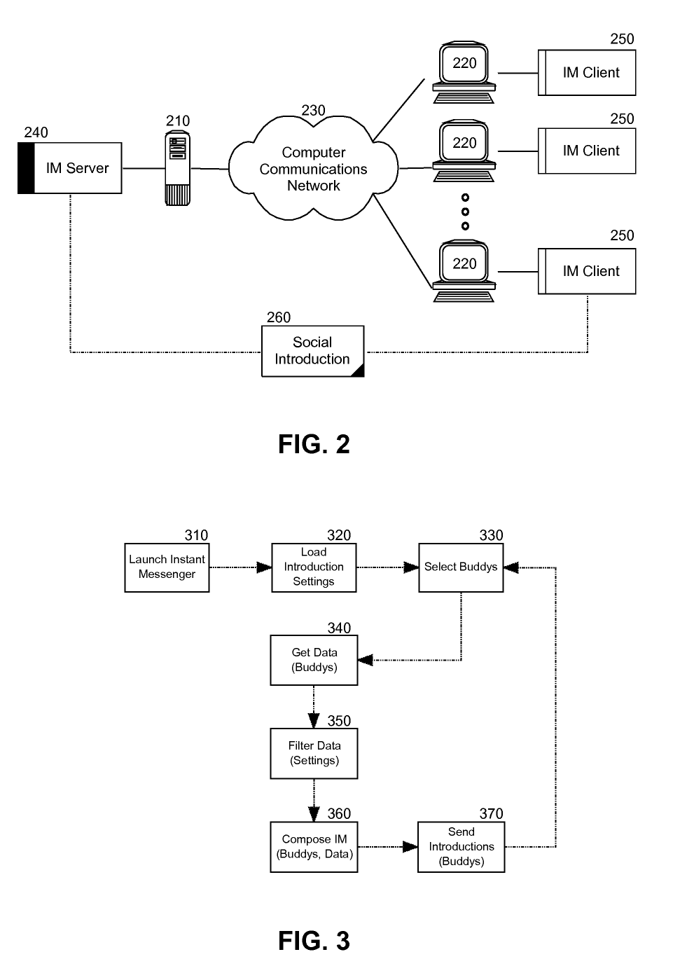

The process described herein can be implemented within an instant messaging data processing system. In further illustration, FIG. 2 schematically depicts an instant messaging data processing system configured for instant messenger based social introductions. The system can include a host server 210 configured for communicative coupling to multiple different computing devices 220 over computer communications network 230. The host server 210 can support the operation of an instant messaging server managing instant messaging sessions amongst instant messaging clients 250, each hosted within a different one of the computing devices 220.

Notably, social introduction logic 260 can be coupled to the instant messaging server 240, each instant messaging client 250 or both. In this regard, the social introduction logic 260 can include stand-alone logic executing separately from the instant messaging server 240 and the instant messaging clients 250, but enjoying a communicative linkage to either or both through inter-process communications, an asynchronous communications link or a programmatic link utilizing an application programming interface for the instant messaging server 240, the instant messaging clients 250, or both. Alternatively, the social introduction logic 260 can be incorporated as program code into the program code of the instant messaging server 240, or as program code of each of the instant messaging clients 250.

In any case, the social introduction logic 260 can include program code enabled to select two or more different contacts in an instant messaging buddy list for introduction. The program code can be further enabled to retrieve and filter descriptive data for the contacts according to established privacy rules or settings for the instant messenger. Yet further the program code can be enabled to generate an introductory instant message for each of the contacts incorporating the descriptive data. Finally, the program code can be enabled to instant message each introductory message to the different respective selected contacts. In this way, the ubiquity of the instant messenger can be employed to emulate express social networking.

In yet further illustration of the operation of the social introduction logic 260, FIG. 3 is a flow chart illustrating a process for instant messenger based social introductions. Beginning in block 310, an instant messenger can be launched through which instant messages can be initiated and exchanged with other instant messaging partners. The other instant messaging partners can be listed as contacts within a buddy list for the instant messenger, or the individual ones of the instant messaging partners can be manually specified. In either case, once the instant messenger has launched, introduction settings can be retrieved for the instant messenger.

The introduction settings can specify among other things the attributes to provide for a selected contact in an introduction instant message. The attributes can include, but are not limited to the name of the contact, the e-mail address of the contact, the phone number or numbers of the contact, the job responsibility and listed skills of the contact, and the manager or managers of the contact. Yet further, the attributes can include an optional field of free form text. Finally, the attributes can specify whether or not notice is to be provided of whether or not the introduction results in the introduced parties contacting one another.

In block 330, two or more contacts in the buddy list can be selected for introduction to one another. Thereafter, in block 340 the attributes for each selected contact can be retrieved and the retrieved attributes can be filtered according to the introduction settings. In block 360, an introduction instant message can be composed. The message can include a note indicating that the introducer intends upon introducing the listed contacts as well as the filtered attributes for the introduced party or parties. Yet further, cultural nuances can be respected in the composed instant message according to a location of the introduced parties. The cultural nuances can include appending formal text to names such as “-San” for Japanese surnames, and listing the introduced contacts in order of seniority to accommodate Chinese and Korean cultural norms.

In block 370, the introductions can be forwarded to the selected contacts. Subsequently, a notification can be provided when the selected contacts contact one another. Also, the introductions can be persisted for re-use in introducing one or more of the selected contacts to yet additional contacts. Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for instant messaging based social introductions, the method comprising:
selecting contacts from a buddy list of an instant messenger;
retrieving attributes for each of the selected contacts;
generating introduction text for each of the selected contacts, the introduction text introducing a particular one of the selected contacts and incorporating attributes for the particular one of the contacts; and,
instant messaging the introduction text for each of the selected contacts to another of the selected contacts.

2. The method of claim 1, wherein retrieving attributes for each of the selected contacts, further comprises filtering the attributes for each of the selected contacts according to pre-stored introduction settings.

3. The method of claim 1, wherein generating introduction text for each of the selected contacts, further comprises modifying the introduction text to account for cultural nuances associated with a culture of a selected one of the contacts.

4. The method of claim 1, further comprising tracking whether or not the selected contacts contact each other through the instant messenger.

5. The method of claim 1, further comprising:
persisting the instant messaged introduction text for a selected one of the contacts receiving the instant messaged introduction text; and,
re-using the persisted instant messaged introduction text in providing a different introduction to a different contact in a buddy list of the selected one of the contacts.

6. An instant messaging data processing system comprising:
an instant messaging server configured for communicative coupling to multiple different instant messaging clients over a computer communications network, each of the instant messaging clients providing a buddy list of contacts; and,
social introduction logic communicatively coupled to the instant messaging clients and the instant messaging server, the logic comprising program code enabled to select contacts from a buddy list of a corresponding one of the instant messaging clients, to retrieve attributes for each of the selected contacts, to generate introduction text for each of the selected contacts, the introduction text introducing a particular one of the selected contacts and incorporating attributes for the particular one of the contacts, and to direct an instant messaging of the introduction text for each of the selected contacts to another of the selected contacts.

7. The system of claim 6, wherein the program code of the social introduction logic is part of the instant messaging server.

8. The system of claim 6, wherein the program code of the social introduction logic is part of each of the instant messaging clients.

9. A computer program product comprising a computer usable medium embodying computer usable program code for instant messaging based social introductions, the computer program product comprising:
computer usable program code for selecting contacts from a buddy list of an instant messenger;
computer usable program code for retrieving attributes for each of the selected contacts;
computer usable program code for generating introduction text for each of the selected contacts, the introduction text introducing a particular one of the selected contacts and incorporating attributes for the particular one of the contacts; and,
computer usable program code for instant messaging the introduction text for each of the selected contacts to another of the selected contacts.

10. The computer program product of claim 9, wherein the computer usable program code for retrieving attributes for each of the selected contacts, further comprises computer usable program code for filtering the attributes for each of the selected contacts according to pre-stored introduction settings.

11. The computer program product of claim 9, wherein the computer usable program code for generating introduction text for each of the selected contacts, further comprises computer usable program code for modifying the introduction text to account for cultural nuances associated with a culture of a selected one of the contacts.

12. The computer program product of claim 9, further comprising computer usable program code for tracking whether or not the selected contacts contact each other through the instant messenger.

13. The computer program product of claim 9, further comprising:
computer usable program code for persisting the instant messaged introduction text for a selected one of the contacts receiving the instant messaged introduction text; and,
computer usable program code for re-using the persisted instant messaged introduction text in providing a different introduction to a different contact in a buddy list of the selected one of the contacts.
